(19) United States
(12) Patent Application Publication
(10) Pub. No.: US 2019/0358521 A1
(43) Pub. Date: Nov. 28, 2019

(54) A BOARD GAME APPARATUS AND A METHOD OF PLACEMENT OF TOKENS ON THE SAME

(71) Applicant: Ashutosh KHURANA, Delhi (IN)

(72) Inventor: Ashutosh KHURANA, Delhi (IN)

(21) Appl. No.: 16/461,377

(22) PCT Filed: Apr. 21, 2018
(86) PCT No.: PCT/IN2018/050242

§ 371 Date: May 16, 2019

(30) Foreign Application Priority Data
Apr. 21, 2017 (IN) 201711014264

(51) Int. Cl. A63F 9/20; A63F 3/00; G09B 1/20; A63F 3/04

(52) U.S. Cl. CPC A63F 9/20; A63F 3/00574; A63F 3/00697; A63F 3/00643; A63F 2003/00476; G09B 1/20; A63F 3/04; A63F 2003/00495; A63F 3/00261

(57) ABSTRACT

A game board apparatus (100) and a method of placement of tokens on the board is disclosed. The game board apparatus (100) comprises a plurality of tokens (130) with a reference image (132) at its each side, a board (110) with plurality of recesses (112) structured on the board. The recesses (112) formed on the board (110) are structured to receive the tokens on the board (110) adjacent to a token (130) already placed on the board (110) or adjacent to the boundary of the board (110) having reference images (132). The token (130) which is to be placed is identified by matching the reference image (132) on the sides of the token (130) already placed on the board (110) with the reference image (132) on the side of the token (130) which is to be placed on the board (110), thereby avoiding displacement of the token (130) on the board (110) when the board (110) is lifted. While placing a token (130) in the recess (112) at the boundary of the board (110), the token (130) which is to be placed is identified by matching reference image (132) at the boundary of the board (110) with the reference image (132) on the side of the token (130) to be placed, thereby avoiding displacement of the token (130) on the board (110) when the board (110) is lifted.

### FIELD OF THE INVENTION

The present invention discloses a board game apparatus and a method for placement of tokens on the same. The board game apparatus comprises of a board with plurality of recesses of shapes like square, rectangle, circular or the like to receive tokens of the shape like square, rectangle, circular or the like respectively and a method of placement of the tokens on the board.

### BACKGROUND OF THE INVENTION

Many games have been created with boards and pieces wherein the pieces are placed on the board. However, the pieces generally fall off or get displaced during playing by accidental movement of the board or if the player accidentally touches the tokens.

Moreover, in our daily life, we are required to visualise what we hear or what we want to say or what we feel or think or even relate to what we see with images stored in our mind. Based on the visualisation and reasoning we use, we associate various visualised mental pictures and we take a conscious action for right/better results or desired/intended outcome.

How to visualise, rotate or manipulate these pictures mentally and then how to sequence/correlate these pictures, is a function of mentally able to perform the process of spatial reasoning. Most of the times, we take an action without creating the correct mental picture(s) or identifying all attributes of the picture or correlating it with other mental/given pictures using mental rotation or applying the reasoning to associate these pictures created in our mind and thus the decision to take What action, when, why, where & how is largely influenced by the way we want to see these pictures based on our past experiences and not actually by what these pictures are.

This learning system in the form of a game is to create hands-on experiences to solve the problem of bridging this gap of thinking existing in most of the members in the society. This gap is existing in adults, and as adults become the source of learning for children, it unknowingly is getting transferred to the next generation.

This learning system, through its progressive structure of method of thinking requiring in solving various situations will enable the adults and children both (as active game players) to identify what is their deep rooted current process of thinking and what they need to change to achieve success in the given game/puzzle/thinking situation. The players can then relate the newly acquired learning, with an access to both the sets of thinking processes i.e. how they used to think in the past and how they should be thinking in their real-life situations to identify where they are using the old (not correct) process or pattern of thinking and thus in turn shall develop a conscious recognition of how they should be thinking in such situations.

The game situations/puzzles have been organised in a progressive structure of thinking processes or methods of thinking required as per the changing game/puzzle situations. This has been done to create this game as a progressive learning tool where the players can bridge the gaps from the basics and go to further complex processes as per self-learning and real-life application pace.

As playing of this game largely requires application of executive function, this game and its intended outcome to become a learning tool, while having the fun and engagement of a game, shall be relevant for a very long time. Even if the player plays the same situations again after 6 months, they will appear new as the player shall be again required to apply different skills under executive function to solve the game/puzzle situation, as long-term memory shall not be of much help in providing the answers achieved during the earlier sessions of game playing. Thus, after a certain period of time, a player can play the situations, where they consciously worked upon to change the process of thinking because of incorrect results/outcome achieved in the game/puzzle situations earlier, to test whether the new conscious thinking process they acquired during earlier sessions is still a part of their subconscious thinking. If not, this will bring a further insight that they need to practice application of missing processes of thinking better. If yes, they can now move on to the next level of complexity in the same game.

This document has been created with an intent to make this learning system and other learning systems invented by the author, due to their relevance in real-life applications for all, to be used by all especially children of age 3-16 years, to become a part of every household so that as a family each one of us can continuously work towards individual growth and growth of the other members of the family and society.

This learning system and others invented by the author should ideally become a part of every academic institution and family at various stages of education process in the life of a child during the age 3-16 years. As these tools do not use any academic content and work on developing appropriate thinking processes, mental behaviour and approach, the learning behind various situations can be delivered to any learner irrespective of whatever socio-economic-cultural or academic background they may come from.

### SUMMARY OF THE INVENTION

A game board apparatus comprising: a plurality of tokens with a reference image at its each side; a board with plurality of recesses structured on the board to receive the token; and a card consisting of a pattern of the tokens to be replicated on the board; wherein the recess first receives the token on the board to correspond to the pattern in the card, recess further receives the tokens adjacent to the tokens already arranged in a pattern on the board by matching the reference image on the sides of the token already arranged on the board and the reference image on the side of the token to be placed, and wherein the recess adjacent to a boundary of the board, receives the token by matching the reference image on the side of the token to be placed with the reference image at the boundary of the board (110), thereby avoiding displacement of the token on the board when the board is lifted.

In an embodiment of the invention, the type of the reference images and/or reference colour on the token is same as the number of sides of the token.

In an embodiment of the invention, each side and/or boundary of the token has the different reference image and/or reference colour.

In an embodiment of the invention, at least two or more sides of the token have the same reference image (132).

In an embodiment of the invention, there is analogy between any two reference images and/or reference colour on the token.

In an embodiment of the invention, the reference images are selected from any one of a smiling face, a sad face, an open mouth, a closed mouth, bird flying in, a bird flying out, a v-shaped image or the like.

In an embodiment of the invention, the board has the reference images and/or reference colour at its each boundary.

In an embodiment of the invention, the number of reference images and/or reference colour formed at each boundary of the board is same as the number of recess adjacent to each boundary of the board.

A game board apparatus comprising: a plurality of tokens with a reference image at its each side and/or boundary; a board with plurality of recesses structured on the board in to receive the token; and wherein the recess receives the tokens on the board adjacent to another token on the board by matching the reference image on the sides of the token placed on the board and the reference image on the side of the token to be placed, and wherein the recess adjacent to a boundary of the board, receives the token by matching the reference image on the side of the token to be placed with the reference image at the boundary of the board, thereby avoiding displacement of the token on the board when the board is lifted.

In an embodiment of the invention, the type of the reference images and/or reference colour on the token is same as the number of sides of the token.

In an embodiment of the invention, each side of the token has the different reference image and/or reference colour.

In an embodiment of the invention, at least two or more sides of the token have the same reference image and/or reference colour.

In an embodiment of the invention, there is analogy between any two reference images and/or reference colour on the token.

In an embodiment of the invention, the reference images are selected from any one of a smiling face, a sad face, an open mouth, a closed mouth, bird flying in, a bird flying out, a v-shaped image or the like.

In an embodiment of the invention, the board has the reference images at its each boundary.

In an embodiment of the invention, the number of reference images formed at each boundary of the board is same as the number of recess adjacent to each boundary of the board.

A method of placement of a token on a board comprising the steps of: arranging the tokens in a pattern provided in a card on the board; identifying a token to be placed on the board by matching the reference image of the token to be placed on the board with a reference image formed on the side of the token placed on the board to place the token in a recess adjacent to a token already placed on the board, and by matching the reference image of the token to be placed on the board with a reference image formed on a boundary of the board on placing the token in a recess adjacent to the boundary of the board; and placing an identified token in any one of, an empty recess adjacent to a token placed on the board and an empty recess adjacent to a boundary of the board, wherein the reference image on the side of the identified token matches with the reference image on the sides of the token placed on the board, and wherein the reference image on the side of identified token matches with the reference image at the boundary of the board.

In an embodiment of the invention, the type of the reference images on the token is same as the number of sides of the token.

In an embodiment of the invention, each side of the token has the different reference image.

In an embodiment of the invention, at least two or more sides of the token have the same reference image.

In an embodiment of the invention, there is analogy between any two reference images on the token.

In an embodiment of the invention, the reference images are selected from any one of a smiling face, a sad face, an open mouth, a closed mouth, bird flying in, a bird flying out, a v-shaped image or the like.

In an embodiment of the invention, the board has the reference images at its each boundary.

In an embodiment of the invention, the number of reference images formed at each boundary of the board is same as the number of recess adjacent to each boundary of the board.

In an embodiment of the invention, the position of the token once placed in the recess formed on the board is fixed.

In an embodiment of the invention, there is at least one player.

In an embodiment of the invention, the method is digital.

A method of placement of a token on a board comprising the steps of: placing the token on the board; identifying another token to be placed on the board by matching the reference image of the token to be placed on the board with a reference image formed on the side of the token placed on the board to place the token in a recess adjacent to a token already placed on the board, and by matching the reference image of the token to be placed on the board with a reference image formed on a boundary of the board on placing the token in a recess adjacent to the boundary of the board; and arranging an identified token in any one of an empty recess adjacent to a token placed on the board, and an empty recess adjacent to a boundary of the board, wherein the reference image on the side of the identified token matches with the reference image on the sides of the token placed on the board, and wherein the reference image on the side of identified token matches with the reference image at the boundary of the board.

In an embodiment of the invention, the type of the reference images on the token is same as the number of sides of the token.

In an embodiment of the invention, each side of the token has the different reference image.

In an embodiment of the invention, at least two or more sides of the token have the same reference image.

In an embodiment of the invention, there is analogy between any two reference images on the token.

In an embodiment of the invention, reference images are selected from any one of a smiling face, a sad face, an open mouth, a closed mouth, bird flying in, a bird flying out, a v-shaped image or the like.

In an embodiment of the invention, the board has the reference images at its each boundary.

In an embodiment of the invention, the number of reference images formed at each boundary of the board is same as the number of recess adjacent to each boundary of the board.

In an embodiment of the invention, the position of the token once placed in the recess formed on the board is fixed.

In an embodiment of the invention, wherein there is at least one player.

In an embodiment of the invention, the method is digital.

### BRIEF DESCRIPTION OF DRAWINGS

FIG. 1 discloses an embodiment of the present invention depicting the game board apparatus with the board and the tokens placed around the board.

FIG. 2 discloses an embodiment of the present invention depicting the board with plurality of recess.

FIG. 3 discloses an embodiment of the present invention with a token having four different reference images.

FIG. 4 discloses an embodiment of the present invention with the bottom view of the tokens.

FIG. 5 discloses an embodiment of the present invention depicting cards with pattern.

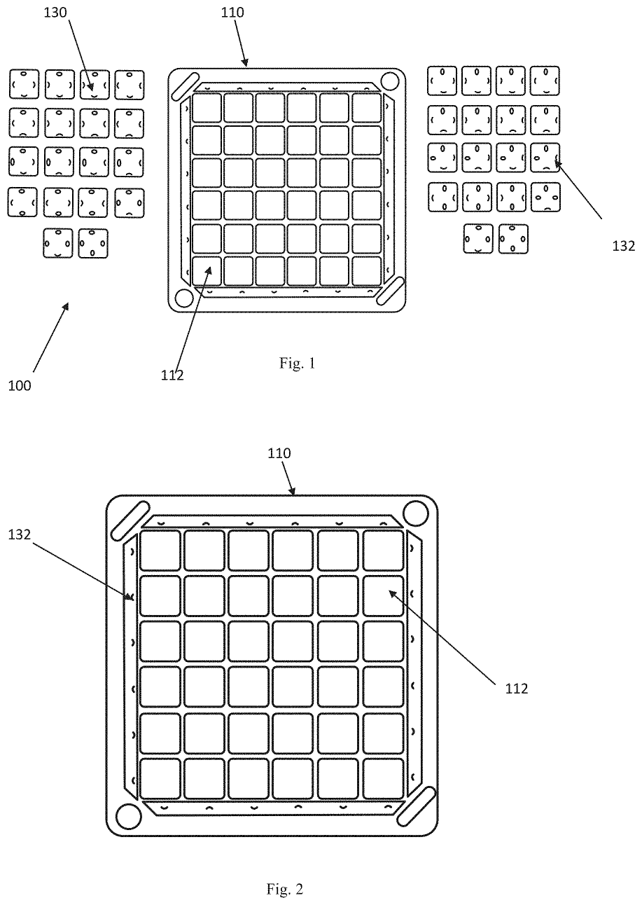

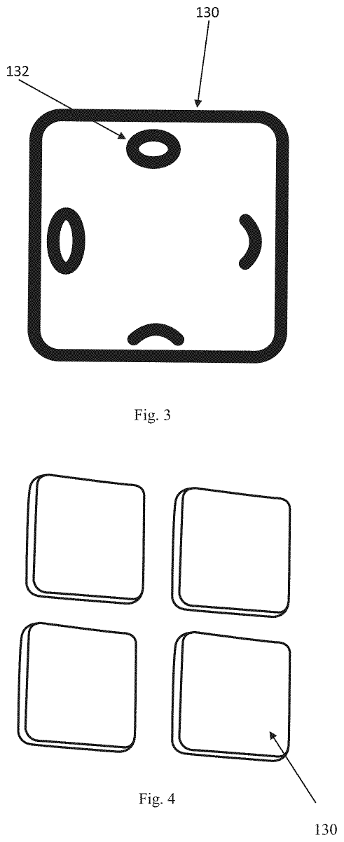

| DESCRIPTION | REFERENCE |
|---|---|
| OF ELEMENTS | NUMERAL |
| Game board apparatus | 100 |
| Board | 110 |
| Recess | 112 |
| Token | 130 |
| Reference Image | 132 |
| Card | 140 |
| Pattern | 142 |

### DETAILED DESCRIPTION OF THE INVENTION

illustrated game board apparatus (100) comprises a plurality of tokens and a board (110) with a reference image (132) at each side of the token (130). For example, if the token (130) is of square shape, there is a reference image (132) at its all four sides. If the token (130) is circular for example, then it may have four reference images (132) at its diametric ends. All reference images (132) on a token (130) can be same, all four can be different. Two reference images (132) can be same and the other two different. Three reference images (132) can be same and so on there can be any combinations of reference images (132) on one token (130).

A board (110) is provided with a plurality of recesses (112) which are structured on the board (110) to receive the tokens. The boundary of the board (110) is also provided with reference images (132) and the number of reference images (132) at each boundary of the board (110) is equal to the number of recesses (112) at each boundary of the board (110).

The recesses (112) formed on the board (110) are structured to receive the tokens on the board (110) adjacent to a token (130) already placed on the board (110) or adjacent to the boundary of the board (110) having reference images (132). The token (130) which is to be placed is identified by matching the reference image (132) on the sides of the token (130) already placed on the board (110) with the reference image (132) on the side of the token (130) which is to be placed on the board (110), thereby avoiding displacement of the token (130) on the board (110) when the board (110) is lifted.

While placing a token (130) in the recess (112) at the boundary of the board (110), the token (130) which is to be placed is identified by matching reference image (132) at the boundary of the board (110) with the reference image (132) on the side of the token (130) to be placed, thereby avoiding displacement of the token (130) on the board (110) when the board (110) is lifted.

In an embodiment of the invention, a card is provided with a pattern (142) formed by the tokens. The pattern (142) is first replicated on the board (110) and then the remaining tokens are to be placed on the board (110) such that the token (130) which is to be placed is identified by matching the reference image (132) on the sides of the token (130) already placed on the board (110) with the and the reference image (132) on the side of the token (130) which is to be placed on the board (110), thereby avoiding displacement of the token (130) on the board (110) when the board (110) is lifted. While placing a token (130) in the recess (112) at the boundary of the board (110), the token (130) which is to be placed is identified by matching reference image (132) at the boundary of the board (110) with the reference image (132) on the side of the token (130) to be placed, thereby avoiding displacement of the token (130) on the board (110) when the board (110) is lifted.

The type of the reference images (132) on the token (130) is same as the number of sides of the token (130) and each side of the token (130) may have a different reference image. At least two or more sides of the token (130) may also have the same reference image.

In an embodiment of the reference images (132) are selected from any one of a smiling face, a sad face, an open mouth and a closed mouth.

The game board apparatus (100) is provided with:
A squared game board (110); with 36 small recesses (112) arranged in a 6×6 grid, each recess (112) having a boundary to hold a squared token (130) inside each of the 36 recesses (112),
A strip of reference images (132) on each of the four sides of the squared game board, each strip having a convex (curved outward) and concave (curved inward) shape image placed alternatively, each image placed exactly opposite to the centre point of each of 6 recesses (112) on the outer most square grid of 6×6 game board
One token (130) each for both the players having a combination of three identifiable symbols of 1 player and one identifiable symbol of the other player, each player to get that token (130) which is having 3 identifiable symbols of his/her own shape. This token (130) will be required only during dual and four player formats. Each player in dual player format and each team in four player format chooses one of these tokens to define which set of 17 other game playing tokens, described below, they will be taking for playing in dual or four player formats.
Two sets of 17 tokens each, each set identifiable with an identifiable symbol to distribute 17 tokens each among two players. Each token (130) in each set of 17 tokens is unique i.e. different from other tokens in the set of 17 tokens. This set will be required in all the 3 formats of game playing—single player, dual player & four player.
Two copies of similar situations booklet with cards arranged in a progressive level of complexity for each player to use their own set of 17 tokens. The difference in both the booklets is only in form of their identifiable symbol used in the situation booklet to play single player game.
A game playing manual.

### Embodiments

This game can be used in 3 different formats of game playing.

In a single player game format by using a situation booklet by using only the set of 17 tokens. In a dual player game format, using all the 18 tokens of each player, by deciding whether they are playing to compete with each other or collaborating with each other to place all 36 tokens on the game board as per the rules of the game. In four player format, each team comprises of 2 players using their own set of 18 tokens collectively, both the team members sit diagonally opposite to each other so that 2 players in the same team get the turn to take an action on their tokens alternatively. All the four players agree to take a turn either in a clockwise or anticlockwise direction of rotation of turn.

In a single player format, the player is supposed to first identify all the tokens given in the situation, out of the 17 tokens, and create the situation using tokens given as a part of the puzzle/card, and then identify the action tokens to fill the empty spaces given in the situation with the action tokens, as per the rules of placement of tokens in the empty spaces of the situations. In some situations, the empty spaces also touch with the outer boundary of the game board and thus will have one side of the empty space in the situation matching with one of concave or convex shape image placed in the strip outside the 6×6 grid i.e. on the outer boundary of 6×6 grid square. In such spaces, the action token (130) has to be placed by keeping in mind the rules of placement of tokens in these empty spaces.

In a single player format, the card shall be treated to be solved successfully by verifying whether all the tokens, situation and action tokens, have been identified correctly and have been placed with each other by satisfying all the conditions of playing the game.

The game cards have been organised in a progressive structure of thinking processes or methods of thinking. This has been done to create each Emojiknot game/situation playing experience as a progressive learning system and tool where the player can bridge the gaps from the basics and go to further complex processes as per self-learning pace and his/her real-life application needs/scenarios. As the level of complexity increases from lower to higher order thinking in the situation cards of the situation booklet, the type of mental skills required to place each token (130) increases from simple to applying complex thinking skills in this Two Dimensional Spatial Reasoning Game set branded as Emojiknot.

Undergoing the lessons based on Emojiknot enables learners learn to identify tokens correctly by creating mental pictures of the token (130) by combining images in 1/2/3/4 parts of each token (130), matching images in 1/2/3/4 parts of each token (130) with images in 1/2/3/4 parts of already placed tokens directly or by doing mental rotation, sequence in forward and/or backwards direction i.e. from start point to the end point and/or from the end point to the start point these pictures to create the right sequence of pictures or identify what will happen in subsequent steps if one picture is used.

In dual and four player formats, the core game mechanics remain the same as in single player format i.e. rules to place the tokens. Thus, dual player and four player format of game playing acts as reinforcement of learning developed during single player game puzzle/card led playing. However, dual player and four player formats provide an excellent opportunity to each player to test their learnt thinking skills and processes in a competitive as well as collaborative format triggering nurturing and development of various emotional and social skills. This extension of single player format game mechanics becoming input of game mechanics for dual player and four player format enables each player to dive deep into their executive functions and executive controls at the same time in both collaborative and competitive game playing formats. It also helps in developing respect and trust in self, team member's and opponent players' executive functions and executive controls.

There are various terms imparted as a part of the game playing learning process which are described below for the learner to learn these terms as an experiential process of game playing. It experientially makes the learners practice various thinking skills in a progressive structure thus making the game playing experience a learning system of all the mental skills required as a part of Spatial Reasoning in Two Dimension environment based on how to visualise, rotate, analyse, evaluate and create desired outcome in each situation in the context of environment i.e. game board in which decision has to be made and thus where and how to place all the tokens given in the situation, as per game playing rules of this game.

### Design Basis—Game Board & Game Tokens

the game board design is based on the number & type of reference images (132) used to design the squared tokens.

If a squared token (130) is divided by 2 diagonal lines, then the squared token (130) will result in 4 triangles with their vertices meeting together at the centre of the square. If there are 2 unique shape-images like concave and convex are being used adjacent to the centre of the base line of each triangle, then there will only be 17 unique tokens possible by using such 2 reference images (132). Each set of 17 tokens having the following set of tokens.
token (130) with 3 parts of the token (130) having reference image (132) of concave shaped picture and the balance 4th part of the token (130) having the identifiable symbol image for each player
token (130) with 3 parts of the token (130) having reference image (132) of convex shaped picture and the balance 4th part of the token (130) having the reference image (132) as identifiable symbol image for each player.
tokens with 3 parts of the token (130) having reference images (132) of combination of concave and convex shaped picture and the balance 4th part of the token (130) having the reference image (132) as identifiable symbol image for each player.
tokens with 2 parts of the token (130) having reference image (132) of concave shaped picture and the balance 2 parts of the token (130) having the reference image (132) as identifiable symbol image for each player.
tokens with 2 parts of the token (130) having reference image (132) of convex shaped picture and the balance 2 parts of the token (130) having the reference image (132) as identifiable symbol image for each player.
tokens with 2 parts of the token (130) having reference image (132) of combination of concave and convex shaped picture and the balance 2 parts of the token (130) having the identifiable symbol image for each player.
token (130) with 1 part of the token (130) having reference image (132) of concave shaped picture and the balance 3 parts of the token (130) having the identifiable symbol image for each player.
token (130) with 1 part of the token (130) having reference image (132) of convex shaped picture and the balance 3 parts of the token (130) having the identifiable symbol image for each player.

In the design of game tokens, there are two types of reference images (132)—concave and convex—have been used which could be created in the form of lips (smiling/frowning lips) or birds flying inside or flying outside, and so on. Another advantage of using a concave and convex shape images is the confusion that they create when a token (130) is being visualised and rotated mentally. If two tokens are placed adjacent to each other with one side/wall of the two tokens touching each other, then the concave shape will always have match of pattern on the adjoining sides/walls with the convex shape. Thus, such a usage of shapes which match with opposite shape picture on the adjoining side(s)/wall(s) to create a symmetry of pattern on adjoining side(s)/wall(s) of tokens, adds to learning outcome design of this game i.e. Spatial Reasoning in two dimensions.

Thus, to make the two players play this game where both the players have equal opportunity, two sets of 17 such unique tokens shall be required for each player, where each player has an identifiable symbol unique to his/her set of tokens, resulting in the game board requiring 34 spaces. In order to use the outer boundary of the game board for adding to the learning inputs created by a static game board environment, when the game playing is dynamic between two/four players, the outer boundary of the game board is lined with strips on all the four sides of 6×6 grid with alternate images of convex and concave shapes (exact same shapes used as part of the game tokens design).

Thus, to make the game board become a neutral, equal opportunity game board, additional 2 tokens have been created—one for each player, based on combination of their unique identifiable symbols. The outer boundary of the game board was utilised further to make the static game board playing an interactive role in the game playing in all the 3 formats i.e. single, dual and four player formats. Further testing of this design was done by placing all the 36 tokens on the game board by following the core game mechanics i.e. the rules of placing the tokens on the game board. The whole design of each of 17 sets of tokens, the outer strip of alternate placement of concave/convex shape images and 2 unique tokens without any convex/concave image. All the 36 tokens qualified the testing and can be placed on the game board as per the rules of placement of tokens on the game board thus making the complete game design a neutral, equal opportunity game set for playing in dual and four player formats.

Based on the above principle, any dimension of the game board or any design of game tokens can be created.

Thus, the number and type of reference images (132) used in the game token (130) design, its impact on the size of the game board to make the game board neutral and equal opportunity game board; method of using the outer boundary of the game board in relationship to the images on the tokens; different levels of learning progression and complexity i.e. method used in identifying the token (130), how to match the tokens with other tokens and strip of images on the outside boundary, from where to start and how to progress to the next subsequent steps to place different tokens, by following the rules of the game, can be created.

This game design thus uses images used to create the tokens, and number of tokens used, and the usage of images on outer boundary of the game board, all in conjunction to create the learning progression and complexity in the card/puzzle design i.e. method used to apply spatial reasoning to place all the tokens, by following the rules of the game, in a two dimensional environment.

All the cards used to play single-player structure in this game have only one unique answer i.e. each action token (130) will have only one unique position and only one definite way of placement after 0/90/180/270 degrees rotation in the final, completely solved situation, by following the rules of the game.

The dual player and four player formats in this game do not require any situation cards as the game board design and design of tokens, both create a neutral, equal opportunity game playing structure for each player. Thus, the dual player and four player formats are based on game playing versions (i.e. how to play) designed and invented in this game below to create competitive and collaborative learning for the players.

### Method

First place the required tokens on the game board by matching the pattern (142) of tokens given in the puzzle/card with the pattern of the game board. Now, take out the action tokens to be placed in the empty positions in the puzzle/card. Place the action tokens in the empty spaces as per the rules of the game.

By identifying the correct tokens and matching the reference images (132) in the action tokens at the adjoining side(s)/wall(s) of already placed situation/action tokens, pattern on all the adjoining side(s)/wall(s) i.e. side(s)/wall(s) of the squares which touch each other after completing the situation, the reference images (132) on all these adjoining side(s)/wall(s) should match i.e. concave with convex shaped image and convex with concave shaped image.

There are situations arranged in an age appropriate structure i.e. situations for age <5 years, 5-7 years, 7-9 years, 9-11 years, 11-13 years & >13 years. Each age band has various thinking processes in-built in it to create varied, progressive experiences for the player to test current thinking process and in-turn strengthen currently existing correct thinking processes and develop new thinking processes.

Though currently a player maybe of 12 years, it is recommended/desired for the player to play the situations from previous age bands first and then proceed to current age band situations.

Such a structure of progressive situation arrangement, gives each player an opportunity to develop/bridge any missing thinking process as per the age and also develops thinking processes of higher age bands. To draw a parallel analogy here, an artificial intelligence to make the game playing process a personalised learning experience has been created through the arrangement of cards.

To make the learner test existing method of thinking around spatial reasoning in two dimensional environment and develop a new method of thinking, in a progressive learning structure created by changing the number of situation and action tokens, type of tokens (images in 1/2/3/4 parts and type of images) and positional placement of situation tokens and empty spaces for placement of action tokens on the game board.

Thus, based on the number of situation and action tokens, type of tokens (images in 1/2/3/4 parts and type of images) and positional placement of situation tokens and empty spaces for action tokens, learning outcome and complexity at each level can be clearly defined and thus progression of learning outcome and complexity can be pre-defined. Thus, progression of learning outcome and learning complexity i.e. methods to do spatial reasoning in two dimensional environment using this game as an aid can be pre-defined.

Tokens Used in the Situation Cards
Situation tokens with images in 1/2/3 parts made of concave and/or convex reference images (132) and the balance parts of the token (130) made of unique identifiable symbol.
Action tokens with images in 1/2/3 parts made of concave and/or convex reference images (132) and the balance parts of the token (130) made of unique identifiable symbol.

Relevant Terms with their Descriptive Meaning Based on this Game
Pattern=Representing arrangement of situation tokens and empty spaces. And, also used for pattern of images on the adjoining side(s)/wall(s) of tokens or where side(s)/wall(s) of tokens touch the strip of images on the outer boundary of the game board
Environment=Place of action i.e. game board
Identifying symbol=Symbol used to identify unique set of 17 or 18 tokens, as the case maybe
Situation tokens=Tokens which are a part of the card (140)
Action tokens=Tokens which will occupy the empty spaces given in the card (140)
Empty spaces=Places in the card (140) where action tokens are to be placed
Possibility=Ways in which a situation and/or action token (130) can be viewed by rotating the token (130) 90/180/270 degrees
Start point=Empty space in the card (140) which is giving maximum information to place an action token (130) or an action token (130) which can be placed in only one empty space (even after 90/180/270 rotations)
Sequencing=Principle used to define which action tokens will come first in the empty spaces and which ones after that and so on in the empty spaces of the situation

Rules of Playing Emojiknot—Single Player Format:
Place all the game tokens outside the game board, on the opposite/other side of the game board i.e. if game board is in front of the player than the tokens kept on the opposite side of the game board but in front of the player for ease of visibility of all the 17 tokens and different reference images (132) on each of the token (130)
There are 2 kinds of tokens required to solve any puzzle/card situation
   Tokens which are a part of the pattern (142) of puzzle/card are called ‘situation tokens’
   Tokens which will fill the empty spaces given in the puzzle/card are called ‘action tokens’
Situation tokens and action tokens required to be used in the puzzle/card to be taken out first out of the set of 17 tokens and placed, depending upon whether the player is left handed or right handed, on the left or right side of the game board
Place one token (130) at a time to replicate/copy the pattern (142) given in the card/puzzle
Now place the pending tokens i.e. action tokens to fill the empty spaces
An action token (130) can only be placed in the empty space if the pattern of reference image (132) given on the sides' of the action token (130) matches with the pattern of the sides of the tokens where ever the action token (130)'s sides shall be touching the sides of existing tokens upon the placement of action token (130)
An action token (130) can be placed in the empty space if the pattern of reference image (132) given on side(s)/wall(s) of the token (130) matches with the pattern of the side(s)/wall(s) of the situation token(s) (130) or already placed action token (130)(s), wherever this action token (130) side(s)/wall(s) touch other tokens' side(s)/wall(s) i.e. concave with convex or convex with concave shapes image and player's identifiable symbol with only his/her identifiable symbol. If such a token (130) is also being placed in outermost lines of squares of 6×6 grid i.e. one/two of their side(s) is facing the line of reference images (132) on outer side of the grid (a part of the game board), then the pattern of image should match there as well.
Token (130) once placed in the squared slot of the game board should not be moved or replaced
Open the card to be solved. The card shall be treated to be solved successfully if all the action tokens have been placed in the empty spaces of the puzzle/card and wherever in the final solved situations any side(s)/wall(s) of tokens touch each other, those side(s)/wall(s) should have the same pattern i.e. concave matching with convex shaped reference image (132) and convex reference image (132) matching with concave image and identifying symbol of the same set of tokens matching with the same set of identifying symbol.
If any of the token(s) (130) has been used which either does not match with the situation or action tokens given in the card (140) or are placed without satisfying the conditions/rules of placement of token (130) i.e. pattern of image(s) of action token (130) given on the side(s)/wall(s) of the action token (130) where the action token (130) touches with the side(s)/wall(s) of situation token(s) (130) or already placed action token(s) (130) does not match after placing the required action token (130), the situation is treated as unsolved and the player removes all the tokens of the situation to attempt to solve the situation card again from the start.

Rules of Playing Emojiknot—Dual Player Format:
As the dual player format is evolution of single player format, without changing the game mechanics, thus the rules of how a token (130) can be placed adjacent to the other token(s) (130) shall remain the same in dual player format as were in single player format. This method of keeping the core game mechanics the same as it was in a single player format, is a unique learning progression design invented in this game, where thinking skills and processes learnt individually by each player now get tested in a dynamic environment of playing with each other.
It is a turn by turn game and each player has to make a move upon his/her turn. Thus, each player has to make a placement till the time no legal placement of token (130) as per core rules of the game playing is possible.
The dual player game format is played as a competition between 2 players to place maximum of their own tokens on the game board as compared to the opposite player. Thus, in this structure, each player gets 18 tokens of each of their set. They start the game by placing each of their 18th token (130) (i.e. the token (130) having no concave or convex images but only the identifying symbols of their own set) on the game board. They place these 2 tokens on the game board without touching each other's token (130)—neither on sides/walls nor at edges. As this 18th token (130) does not have any concave or convex image thus this token (130) cannot be placed also on the outermost squares of 6×6 grid, as immediately outside the outermost squares there is strip of images of alternate concave and convex images. And, any token (130) to be placed in this outermost grid, the side(s)/wall(s) of this token (130) touching the strip of images line, should also have the match of pattern of images (imagining the outer strip image as an already placed token (130) outside the game board). Thus, where the side(s)/wall(s) of the action token (130) touches with the line of image outside the game board, the side(s)/wall(s) of the action token (130) facing the outside strip line should have the same pattern image. For example, if the outside line of images has the convex image, then the token (130)'s side/wall facing the outside line of image will be required to have a concave image. As the 18^{th} token (130) does not have any concave or convex image, it cannot be placed in any of the outermost squares of 6×6 grid.
The players play the game turn-by-turn after each placing their 18th token (130) as explained above. Now, they place any one token (130) from their set of 17th token (130) on the game board. The rule of placement of any token (130) to continue to play the game is—every time a player places any of his/her set of 17 tokens, the token (130) can only be placed on the game board only if token (130) touches at least one side/wall of already placed token(s) (130) i.e. the player cannot place the token (130) in a standalone empty space on the game board. This token (130) being placed on the game board should match concave with convex or convex with concave image, player's identifiable symbol with only his/her identifiable symbol (and not of the other player's identifiable symbol as both the symbols are different and thus the pattern at such a place will not be matching at the adjoining side(s)/wall(s)) and if such a token (130) is also being placed in outermost squares of 6×6 grid i.e. one/two of their side(s)/wall(s) facing the line of images on outer side of the grid (a part of the game board) the pattern should match there as well i.e. all the rules of matching pattern while placing a token (130).
If a player upon his/her turn is not able to find a place to place his/her token (130) as per the rules of the placement of tokens, shall say ‘skip/pass’ and the other player takes the turn i.e. the player who has said ‘skip/pass’ has already missed the opportunity to place one token (130) and thus will now have one token (130) extra left than the other player i.e. increased chances of losing the game.
If a player has exhausted all legal placements possible to place a token (130), the other player continues to play the game till left with no legal placement possible. In such a scenario, the player who has a legal placement makes a move, then the other player checks whether any legal placement has got created due to the move taken by the other player, if yes, makes a placement of token (130) or just says ‘pass/skip’ for the other player to make a placement.
The winner is decided on the basis of which player has minimum number of tokens left to be placed on the game board. This minimum numbers of tokens left can be defined by in a simple way. They can decide to call the minimum number purely on the basis of actual, physical tokens left with each other once all the players have exhausted their legal moves as per the rules of the game play.
They can also use the advance fair-play method to define the winner. They can decide by adding count of all those places left blank on the game board where a particular player might have been able to possibly place the token (130) but could not place the token (130), to the total count of physical tokens left of that player. Like a place got left empty on the game board by having a combination of convex and/or concave images with at least one identifiable symbol of one player. This place could have been used by the player who is using that identifiable symbol but could not use that space to place a token (130) even after creating an opportunity for self to place his/her token (130) at this empty space. Such a space will be added as additional token (130) assuming it to be the physical token (130) left in the count of tokens left of this particular player. The reason for doing this is, that this player did not play it fair where though this player created a space for self which could not have been used by the other player but did not use it for self. Such spaces are called usable spaces but made dead without using them. All the empty spaces which are made of 4 images of concave and/or convex shapes with no image of any identifiable symbol, are the spaces which cannot be used by any of the player, and thus are not added to any one's count. Similarly, any empty space which has a combination of identifiable symbols of both the players, cannot be used by any of the player, hence are also not added to any one's count. Such spaces are called dead spaces which cannot be used at all by any of the player. This is an advanced version of defining the rule of counting the number of tokens left. This is created for those seasoned players who after trying tactical approach or predefined strategy of blocking the opportunities for the other player by making their symbols point most of the times outside towards the open empty spaces, are now wanting to play and win the game through a fair-play based on the strength of their thinking skills and not by using blocking the opponent as a pre-defined strategy.
In case a player makes a placement of token (130) which is not permitted as per the core rules of the game, the other player can challenge the move. In such a scenario, the player who made an illegal move is at the mercy of other player. The other player can chose any, but only one, of the following options. This situation only arises if the other player has spotted the illegal placement at the time of placement itself, during the current round, and not during the later rounds. If the other player has not been able to spot the illegal placement before making his/her placement, then it cannot be challenged later.
   Pardon the other player's illegal placement and allow the other player to change the move to a legal placement.
   Make the other player undo the illegal placement and make the other player skip the chance, thus the player who made an illegal move will now have one token (130) extra as compared to the other player during this round of turn-by-turn placement of tokens.
The game ends when both the opponent players are left with no legal move to make on the game board.
Both the players, while playing the game, are required to keep their set of tokens on their side in such a way that they are always visible to the other player. This is for the players to be able to define which of their tokens they would like to place, when and where, based on what has already been placed by the other player, what tokens are left and what all placement options are still possible on the game board.
The player has to place that token (130) on the game board which he/she touches first. So, both the players should first use spatial reasoning and then touch the token (130) they want to place.
The player after picking the token (130) rotates the token (130) outside the game board to define how he/she is going to place the token (130) on the game board, at pre-define empty place. The checking of token (130) placement possibilities by bringing the token (130) on top of the game board, matching the patterns with or without rotation and then identifying specific places of placement on the game board is not allowed, and is counted as an illegal move. This can be challenged by the other player as per the rules described above of illegal move/placement.
Both the players agree on a maximum permitted time allowed to think and make a placement of token (130) on the game board. Any player who exceeds the time limit, misses the turn to place the token (130) during that round.
As the design of whole game is neutral, equal opportunity design, two players can also play the game in collaborative format where they jointly discover how they can place all the 36 tokens on the game board by following all the rules of placement of this game.

Additional Rules of Game Play—Four Player Format
As the four player format is evolution of single & dual player format, without changing the game mechanics, thus the rules of movement of token(s) (130) of single player and other rules used of dual player format w.r.t. game playing and winning will remain the same for four player format as well. This method of keeping the rules of single player core game mechanics and dual player competitive rules the same, is a unique learning progression design invented in this game, where thinking skills and processes learnt individually as well as in competitive format by each player now get tested in a dynamic environment of playing in collaborative and competitive environment, both being created in four player format at the same time.
   All the rules of single and dual player format apply in four player format.
   The only difference from dual player in four player format is, in four player format there are 2 players competing with opponent team of 2 members. So, each team is made of 2 players. The team members of respective team sit diagonally opposite to each other and use their set of 17 tokens to make a move on the game board at alternative intervals. The game is played in clockwise or anticlockwise direction, turn-by-turn.
   The players in the same team are collaborating with each other to win but are not allowed to talk or communicate in any form, verbal or non-verbal, with their team member. Thus, they now learn to apply skills learnt in a single & dual player format in a collaborative yet competitive environment, both.
They can play the four-player game in two formats—
   Place a token (130) as per their turn from their set of 17 tokens in a clockwise or anticlockwise direction of turn of placement.
   Play the advance version where upon the turn of one player of a particular team, this player identifies the token (130) he/she would want to place on the game board by touching that token (130) with one of the finger in such a way that his/her team member along with other the members of opponent team can clearly see this identified token (130). Now, the other team member chooses to define where he/she would actually like to place the token (130). So, upon the turn of any player, in clockwise or anticlockwise direction, each player is identifying the token (130) for placement whereas the decision of where and how to place along with action of doing the actual placement of this identified token (130) is being done by his/her team member. This system of token (130) being identified by one member but placed on the game board by the other member continues as a game playing process for all the players. The players here again as a team are collaborating with each other to win but are not allowed to talk or communicate in any form, verbal or non-verbal, with their team member. In this version, they are required to demonstrate a very high degree of trust, faith, and team effort to understand each other's skills and competencies. Thus, they now learn to apply skills learnt in a single, dual and earlier version of four player format in a collaborative yet competitive environment, both.

The winning is decided as explained in dual player format. They can chose simple or advance format for winner team declaration as explained in dual player format.

Learning System Progression on Method of Spatial Reasoning in Two Dimensions

Single Player Booklet progression—based on token design using 1 convex and 1 concave image resulting in 17 unique tokens (balance part of tokens filled with unique identification symbol)

6 progressive levels
for Age 3-16 years
Each level described below with an indicative situation from that level

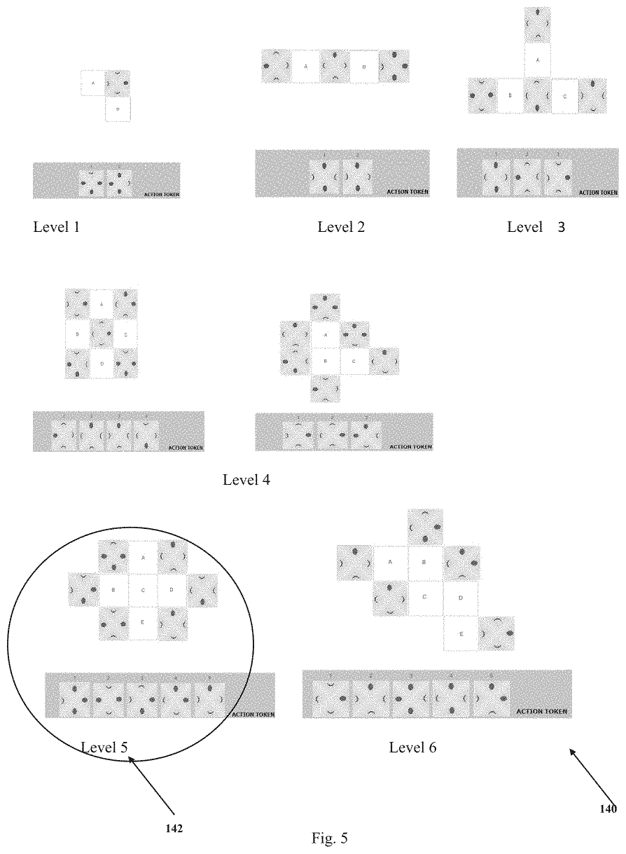

### Level 1 [FIG. 5]

Minimum 2 tokens situation including situation tokens and action tokens; action tokens equal/more than number of empty spaces in the situation; one side/wall matching situations i.e. one image of action token (130) to be created as mental picture to be matched with one image of situation token (130); all tokens can be placed directly without rotation; all action tokens with single possible empty space of placement.

### Level 2 [FIG. 5]

Minimum 3 tokens situation including situation tokens and action tokens; action tokens equal/more than number of empty spaces in the situation; one/two side(s)/wall(s) matching situations i.e. one/two images of an action token (130) to be created and combined as mental picture and to be matched with one/two images of situation token(s) (130) and/or already placed action token (130)(s); all tokens can be placed directly without rotation; all action tokens with single possible empty space of placement.

### Level 3 [FIG. 5]

Minimum 4 tokens situation including situation tokens and action tokens; action tokens equal/more than number of empty spaces in the situation; one/two side(s)/wall(s) matching situations i.e. one/two images of an action token (130) to be created and combined as mental picture and to be matched with one/two images of situation token(s) (130) and/or already placed action token (130)(s); matching with or without rotation of action tokens; all action tokens with single possible empty space of placement.

### Level 4 [FIG. 5]

Minimum 5 tokens situation including situation tokens and action tokens; action tokens equal/more than number of empty spaces in the situation; one/two/three sides matching situations i.e. one/two/three images of an action token (130) to be created and combined as mental picture and to be matched with one/two/three images of situation token(s) (130) and/or already placed action token (130); matching with or without rotation of action tokens; at least one action token with single possible empty space of placement i.e. clear start point.

Minimum 6 tokens situation including situation tokens and action tokens; action tokens equal/more than number of empty spaces in the situation; one/two/three sides matching situations i.e. one/two/three images of an action token (130) to be created and combined as mental picture to be matched with one/two/three images of situation token(s) (130) and/or already placed action token (130); matching with or without rotation of action tokens; single/dual start points.

Minimum 7 tokens (130) situation including situation tokens and action tokens; action tokens equal/more than number of empty spaces in the situation; two/three/four sides matching situations i.e. two/three/four images of an action token (130) to be created

and combined as mental picture and to be matched with two/three/four images of situation token(s) (130) and/or already placed action token(s) (130); matching with or without rotation of action tokens; single/dual start points.

### Level 6 [FIG. 5]

Minimum 8 tokens situation including situation tokens and action tokens; action tokens equal/more than number of empty spaces in the situation; two/three/four sides matching situations i.e. two/three/four images of an action token (130) to be created and combined as mental picture and to be matched with two/three/four images of situation token(s) (130) and/or already placed action token(s) (130); matching with or without rotation of action tokens; multiple start points resulting in identifying correct placement through identifying and validating multiple sequencing of action tokens.

1. A game board apparatus (100) comprising:
a plurality of tokens (130) with a reference image (132) at its each side;
a board (110) with plurality of recesses (112) structured on the board (110) to receive the token (130); and
a card consisting of a pattern (142) of the tokens (130) to be replicated on the board (110);
wherein the recess (112) first receives the token (130) on the board (110) to correspond to the pattern (142) in the card, recess further (112) receives the tokens (130) adjacent to the tokens (130) already arranged in a pattern (142) on the board (110) by matching the reference image (132) on the sides of the token (130) already arranged on the board (110) and the reference image (132) on the side of the token (130) to be placed, and
wherein the recess (112) adjacent to a boundary of the board (110), receives the token (130) by matching the reference image (132) on the side of the token (130) to be placed with the reference image (132) at the boundary of the board (110), thereby avoiding displacement of the token (130) on the board (110) when the board (110) is lifted.

2. The game board apparatus (100) as claimed in claim 1, wherein the type of the reference images (132) on the token (130) is same as the number of sides of the token (130).

3. The game board apparatus (100) as claimed in claim 1, wherein each side of the token (130) has the different reference image (132).

4. The game board apparatus (100) as claimed in claim 1, wherein at least two or more sides of the token (130) have the same reference image (132).

5. The game board apparatus (100) as claimed in claim 1, wherein there is analogy between any two reference images (132) on the token.

6. The game board apparatus (100) as claimed in claim 5, wherein the reference images (132) are selected from any one of a smiling face, a sad face, an open mouth, a closed mouth, bird flying in, a bird flying out, a v-shaped image or the like.

7. The game board apparatus (100) as claimed in claim 1, wherein the board (110) has the reference images (132) at its each boundary.

8. The game board apparatus (100) as claimed in claim 1, wherein the number of reference images (132) formed at each boundary of the board (110) is same as the number of recess (112) adjacent to each boundary of the board (110).

9. A game board apparatus (100) comprising:
a plurality of tokens (130) with a reference image (132) at its each side;
a board (110) with plurality of recesses structured on the board (110) in to receive the token (130); and
wherein the recess (112) receives the tokens (130) on the board (110) adjacent to another token (130) on the board (110) by matching the reference image (132) on the sides of the token (130) placed on the board (110) and the reference image (132) on the side of the token (130) to be placed, and
wherein the recess (112) adjacent to a boundary of the board (110), receives the token (130) by matching the reference image (132) on the side of the token (130) to be placed with the reference image (132) at the boundary of the board (110), thereby avoiding displacement of the token (130) on the board (110) when the board (110) is lifted.

10. The game board apparatus (100) as claimed in claim 9, wherein the type of the reference images (132) on the token (130) is same as the number of sides of the token (130).

11. The game board apparatus (100) as claimed in claim 9, wherein each side of the token (130) has the different reference image (132).

12. The game board apparatus (100) as claimed in claim 9, wherein at least two or more sides of the token (130) have the same reference image (132).

13. The game board apparatus (100) as claimed in claim 9, wherein there is analogy between any two reference images (132) on the token.

14. The game board apparatus (100) as claimed in claim 13, wherein the reference images (132) are selected from any one of a smiling face, a sad face, an open mouth, a closed mouth, bird flying in, a bird flying out, a v-shaped image or the like.

15. The game board apparatus (100) as claimed in claim 9, wherein the board (110) has the reference images (132) at its each boundary.

16. The game board apparatus (100) as claimed in claim 9, wherein the number of reference images (132) formed at each boundary of the board (110) is same as the number of recess (112) adjacent to each boundary of the board (110).

17. A method of placement of a token (130) on a board (110) comprising the steps of:
arranging the tokens (130) in a pattern (142) provided in a card on the board (110);
identifying a token (130) to be placed on the board by matching the reference image (132) of the token to be place on the board with a reference image (132) formed on the side of the token (130) placed on the board (110) to place the token (130) in a recess (112) adjacent to a token (130) already placed on the board (110), and by matching the reference image (132) of the token (130) to be placed on the board (110) with a reference image (132) formed on a boundary of the board (110) on placing the token (130) in a recess (112) adjacent to the boundary of the board (110); and
placing an identified token (130) in any one of, an empty recess (112) adjacent to a token (130) placed on the board (110) and an empty recess (112) adjacent to a boundary of the board (110),
wherein the reference image (132) on the side of the identified token (130) matches with the reference image (132) on the sides of the token (130) placed on the board (110), and
wherein the reference image (132) on the side of identified token (130) matches with the reference image (132) at the boundary of the board (110).

18. The method of placement of a token (130) on a board (110) as claimed in claim 17, wherein the type of the reference images (132) on the token (130) is same as the number of sides of the token (130).

19. The method of placement of a token (130) on a board (110) as claimed in claim 17, wherein each side of the token (130) has the different reference image (132).

20. The method of placement of a token (130) on a board (110) as claimed in claim 17, wherein at least two or more sides of the token (130) have the same reference image (132).

21. The method of placement of a token (130) on a board (110) as claimed in claim 17, wherein there is analogy between any two reference images on the token.

22. The method of placement of a token (130) on a board (110) as claimed in claim 21, wherein the reference images (132) are selected from any one of a smiling face, a sad face, an open mouth, a closed mouth, bird flying in, a bird flying out, a v-shaped image or the like.

23. The method of placement of a token (130) on a board (110) as claimed in claim 17, wherein the board (110) has the reference images (132) at its each boundary.

24. The method of placement of a token (130) on a board (110) as claimed in claim 17, wherein the number of reference images (132) formed at each boundary of the board (110) is same as the number of recess (112) adjacent to each boundary of the board (110).

25. The method of placement of token (130) on the board (110) as claimed in claim 17, wherein the position of the token (130) once placed in the recess (112) formed on the board (110) is fixed.

26. The method of placement of token (130) on the board (110) as claimed in claim 17, wherein there is at least one player.

27. The method of placement of token (130) on the board (110) as claimed in claim 17, wherein the method is digital.

28. A method of placement of a token (130) on a board (110) comprising the steps of:
placing the token (130) on the board (110);
identifying another token (130) to be placed on the board by matching the reference image (132) of the token to be place on the board with a reference image (132) formed on the side of the token (130) placed on the board (110) to place the token (130) in a recess (112) adjacent to a token (130) already placed on the board (110), and by matching the reference image (132) of the token (130) to be placed on the board (110) with a reference image (132) formed on a boundary of the board (110) on placing the token (130) in a recess (112) adjacent to the boundary of the board (110); and
arranging an identified token (130) in any one of an empty recess (112) adjacent to a token (130) placed on the board (110), and an empty recess (112) adjacent to a boundary of the board (110),
wherein the reference image (132) on the side of the identified token (130) matches with the reference image (132) on the sides of the token (130) placed on the board (110), and
wherein the reference image (132) on the side of identified token (130) matches with the reference image (132) at the boundary of the board (110).

29. The method of placement of a token (130) on a board (110) as claimed in claim 28, wherein the type of the reference images (132) on the token (130) is same as the number of sides of the token (130).

30. The method of placement of a token (130) on a board (110) as claimed in claim 28, wherein each side of the token (130) has the different reference image (132).

31. The method of placement of a token (130) on a board (110) as claimed in claim 28, wherein at least two or more sides of the token (130) have the same reference image (132).

32. The method of placement of a token (130) on a board (110) as claimed in claim 28, wherein there is analogy between any two reference images on the token.

33. The method of placement of a token (130) on a board (110) as claimed in claim 32, wherein the reference images (132) are selected from any one of a smiling face, a sad face, an open mouth, a closed mouth, bird flying in, a bird flying out, a v-shaped image or the like.

34. The method of placement of a token (130) on a board (110) as claimed in claim 28, wherein the board (110) has the reference images (132) at its each boundary.

35. The method of placement of a token (130) on a board (110) as claimed in claim 28, wherein the number of reference images (132) formed at each boundary of the board (110) is same as the number of recess (112) adjacent to each boundary of the board (110).

36. The method of placement of token (130) on the board (110) as claimed in claim 28, wherein the position of the token (130) once placed in the recess (112) formed on the board (110) is fixed.

37. The method of placement of token (130) on the board (110) as claimed in claim 28, wherein there is at least one player.

38. The method of placement of token (130) on the board (110) as claimed in claim 28, wherein the method is digital.
